(19) United States
(12) Patent Application Publication
(10) Pub. No.: US 2011/0182534 A1
(43) Pub. Date: Jul. 28, 2011

(54) POSITIONABLE BALL BEARING

(76) Inventor: Chao-Ken Chen, Changhua Conuty (TW)

(21) Appl. No.: 12/954,671

(22) Filed: Nov. 25, 2010

(30) Foreign Application Priority Data
Jan. 22, 2010 (TW) 099201268

(51) Int. Cl. F16C 29/04

(52) U.S. Cl. 384/49

(57) ABSTRACT

A ball bearing with multi-step is disclosed. The bearing has a round seat with rolling balls in annular arrangement. A flexible depressor is provided on the round seat. A cap covers the round seat and accommodates the flexible depressor. The center of the cap is provided with a shaft base for securing the depressor to press the round seat. The flexible depressor is provided with a plurality of holes corresponding to the rolling balls. A positioning effect arises when the rolling balls are just embedded in the holes. The rolling balls diverge from the holes to rotate when the cap is forced to rotate against the round seat. The depressor is deformed by the rolling balls. Next positioning effect will not arise until the rolling balls are embedded in the holes again.

### BACKGROUND OF THE INVENTION

1. Technical Field The invention generally relates to bearings, particularly to ball bearings.

2. Related Art

Ball bearings are frequently used to provide a rotational connection between two parts. They are extensively adopted because of low costs, long durability and low resistance. However, all conventional ball bearings are of a continuous rotation type without positioning function in a rotational process. But some household appliances, for example, rotary elbows of chairs and cantilevers of desk lamps, indeed need ball bearing with positioning function. It is hard to keep a specific position if a continuous rotation type ball bearing is employed. Alternatively, an additional positioning device may be added to stop the bearing rotating. However, the additional positioning device usually has a complicated structure and high costs. Further, everytime a user want to adjust the position, he or she must first release the positioning device and re-lock the positioning device after adjusting. It is very inconvenient for users.

### SUMMARY OF THE INVENTION

A primary object of the invention is to provide a positionable ball bearing which can be automatically positioned in its rotational process and release positioning simply by slightly forcing to rotate without any other releasing or locking operations. The ball bearing of the invention is so convenient for users.

Another object of the invention is to provide a positionable ball bearing which provides the positioning function within the bearing without any additionally external positioning device. Thus the ball bearing of the invention can simplify structure and reduce costs.

To accomplish the above objects, the bearing has a round seat with rolling balls in annular arrangement. A flexible depressor is provided on the round seat. A cap covers the round seat and accommodates the flexible depressor. The center of the cap is provided with a shaft base for securing the depressor to press the round seat. The flexible depressor is provided with a plurality of holes corresponding to the rolling balls. A positioning effect arises when the rolling balls are just embedded in the holes. The rolling balls diverge from the holes to rotate when the cap is forced to rotate against the round seat. The depressor is deformed by the rolling balls. Next positioning effect will not arise until the rolling balls are embedded in the holes again.

### Brief Description of the Invention

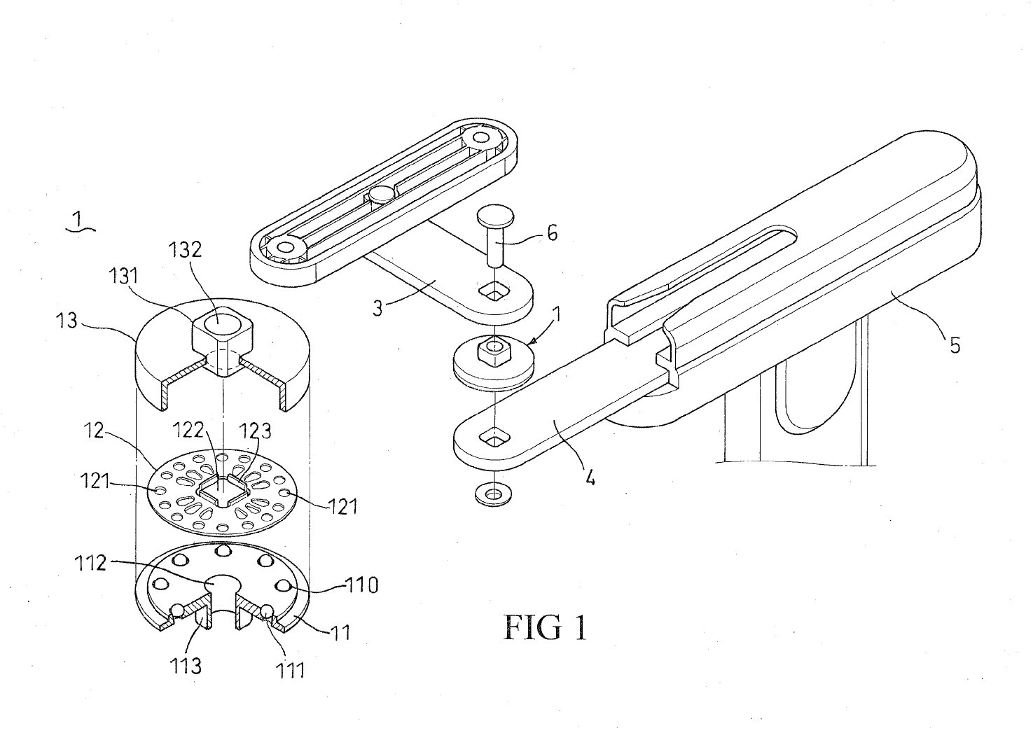

FIG. 1 is a perspective view of the invention;

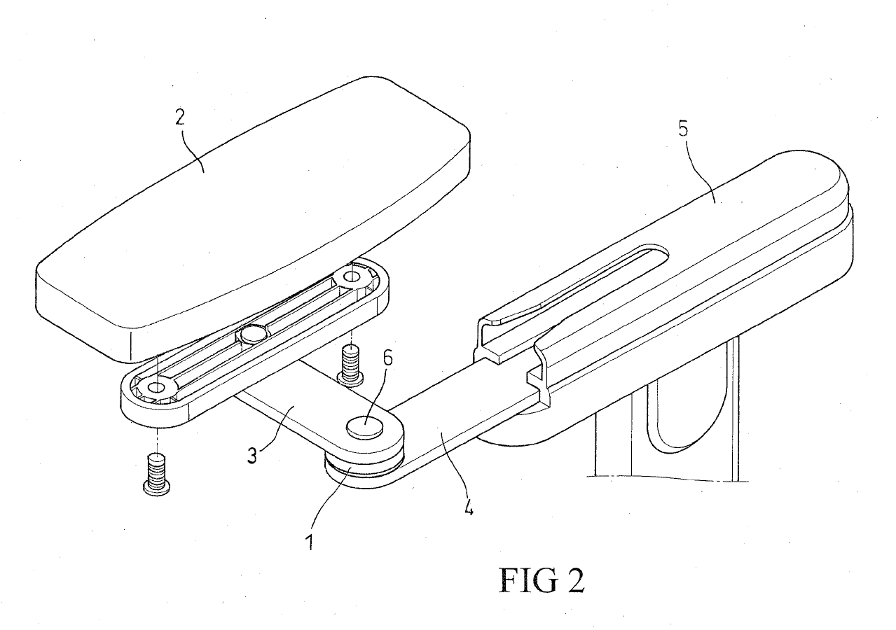

FIG. 2 shows a using status of FIG. 1;

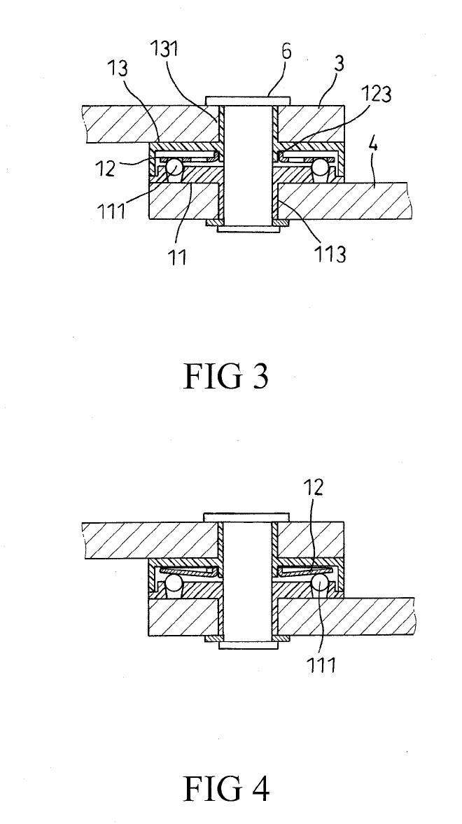

FIG. 3 is a cross-sectional view of the invention in a positioned status; and

FIG. 4 is a cross-sectional view of the invention in a rotating status.

### DETAILED DESCRIPTION OF THE INVENTION

FIGS. 1 and 2 are a perspective view of a chair elbow using the positionable ball bearing of the invention and a using status thereof, respectively. The bearing can provide the elbow a positioning function in its rotational process when the bearing is employed in the elbow. Thus the elbow does not rotate arbitrarily. In other words, the elbow can be not only rotated but also positioned. The elbow has a slidable armrest 2. The armrest 2 is pivotally connected at an end of a rotating plate 3. The other end of the rotating plate 3 is pivotally connected at a sliding plate 4 by the positionable ball bearing 1 of the invention. The sliding plate 4 can slid in or out of the elbow 5. The rotating plate 3 can positionably rotate with 360 degree against the sliding plate 4 when the sliding plate 4 protrudes from the elbow 5. For example, a step between two adjacent positioning points can be 15 or 30 degree. The positioning points merely make a certain resistance against rotation of the rotating plate 3 instead of completely preventing from rotation. Slightly applying a force to rotate the rotating plate 3 can release the positioned status to rotate.

The positionable ball bearing 1 is composed of a round seat 11, a flexible depressor 12 and a cap 13. The round seat 11 is provided with a plurality of rolling balls 111. The rolling balls 111 are disposed in an annular arrangement with an identical pitch. The rolling balls 111 are rotarily disposed on the round seat 11 with exposure of about one second of volume. A first shaft base 113 is protrudent from a center of the round seat 11. The first shaft base 113, whose outline may be a cuboid or many-sided body, has a first shaft hole 112 therein. The flexible depressor 12 is a round disk. And a through hole 122 is provided at its center. The flexible depressor 12 is provided with circular holes 121 corresponding to the rolling balls 111. The circular holes are the same as or an integer multiple of the rolling balls 111 in number. As can be seen in FIG. 1, the quantity of the circular holes 121 is two times of the rolling balls 111 for forming more compact positioning points. That is to say, the pitch of any two adjacent positioning points is one second of that of the rolling balls 111. The pitch of any two adjacent positioning points is just the same as that of the rolling balls 111 if the circular holes 121 are the same as the rolling balls 111 in number.

The flexible depressor 12 is disposed on the rolling balls 111 to press them. The cap 13 covers the round seat 11 to accommodate the flexible depressor 12 therein. A second shaft base 131, whose outline may be a cuboid or many-sided body, is disposed at the center of the cap 13 and extends inwards and outwards. The inward part of the second shaft base 131 penetrates into the through hole 122 of the flexible depressor 12 to secure the flexible depressor 12. The cap 13 and flexible 12 can be integrated because of the non-round shape of the second shaft base 131. The second shaft base 131 is provided with a second shaft hole 132 therein. The first shaft hole 112, through hole 122 and second shaft hole 132 directly communicate with each other to be penetrated by a central rod 6 for securing the bearing 1. Bending edges 123 extend from margins of the through hole 122 of the flexible depressor 12 for leaning against the cap 13.

FIG. 3 is a cross-sectional view of the ball bearing in the positioned status. The flexible depressor 12 presses the round seat 11. A positioned status is made once the rolling balls are embedded into the circular holes 121. When the cap 13 is forced to rotate with the flexible depressor 12 against the round seat 11, as shown in FIG. 4, the rolling balls 111 diverge from the circular holes to rotate. And the flexible depressor 12 is deformed by being leaned by the rolling balls 111 (the central portion of the flexible depressor 12 is leaned by the bending edges 123 so it is not deformed). At this time, though the rolling balls 111 are pressed by the flexible depressor 12, they still can rotate. This makes the flexible depressor 12 also can rotate smoothly. When the rolling balls 111 move to the position of the circular holes 121 again, they will be automatically embedded into the circular holes 121 to make another positioned status by means of pressure from the flexible depressor 12. Meanwhile the flexible depressor 12 restores its original shape.

It should be noted that the flexible depressor 12 and cap 13 are separately disposed for allowing easy replacement of the flexible depressor 12 after elasticity fatigue or damage.

It will be appreciated by persons skilled in the art that the above embodiments have been described by way of example only and not in any limitative sense, and that various alterations and modifications are possible without departure from the scope of the invention as defined by the appended claims.

What is claimed is:

1. A ball bearing comprising:
a round seat, provided with a plurality of rolling balls in an annular arrangement with an identical pitch, wherein the round seat has a first shaft base protrudent from a center thereof and a first shaft hole is disposed in the first shaft base;
a flexible depressor, being a round disk on the round seat, having a through hole at a center thereof, and being provided with circular holes corresponding to the rolling balls; and
a cap covering the round seat to accommodate the flexible depressor therein, wherein the cap has a second shaft base at a center thereof for penetrating into the through hole to secure the flexible depressor, the second shaft base is provided with a second shaft hole therein and the first shaft hole, the through hole and the second shaft hole directly communicate with each other;
wherein the flexible depressor presses the round seat, a positioned status can not be formed until the circular holes are embedded by the rolling balls, when the cap is forced to rotate with the flexible depressor against the round seat, the rolling balls diverge from the circular holes to rotate and the flexible depressor is deformed by being leaned by the rolling balls, and when the rolling balls move to a position of the circular holes again, they will be automatically embedded into the circular holes to make another positioned status by means of pressure from the flexible depressor.

2. The ball bearing of claim 1, wherein the circular holes are the same as the rolling balls in number.

3. The ball bearing of claim 1, wherein the circular holes are an integer multiple of the rolling balls in number.

4. The ball bearing of claim 1, wherein the second shaft base and the flexible depressor are formed integratedly.

5. The ball bearing of claim 1, wherein an outline of the second shaft base is a many-sided body.

6. The ball bearing of claim 1, wherein the second shaft base extends from the cap inwards and outwards, and an inward part of the second shaft base penetrates into the through hole.

7. The ball bearing of claim 6, further comprising bending edges extending from margins of the through hole of the flexible depressor for leaning against the cap.

8. The ball bearing of claim 1, further comprising a central rod penetrating a passage formed by the first shaft hole, the through hole and the second shaft hole.
